(19) United States
(12) Patent Application Publication
(10) Pub. No.: US 2004/0211449 A1
(43) Pub. Date: Oct. 28, 2004

(54) Cleaning apparatus and substrate processing apparatus

(75) Inventors: Ryu Yokomoto, Kyoto (JP); Toshio Hiroe, Kyoto (JP); Koji Hasegawa, Kyoto (JP)

Correspondence Address: OSTROLENK FABER GERB & SOFFEN, 1180 AVENUE OF THE AMERICAS, NEW YORK, NY, 100368403

(73) Assignee: Dainippon Screen Mfg. Co., Ltd.

(21) Appl. No.: 10/832,127

(22) Filed: Apr. 26, 2004

(30) Foreign Application Priority Data
Apr. 25, 2003 (JP) JP2003-121398

(51) Int. Cl. B08B 3/00

(52) U.S. Cl. 134/61; 134/95.2; 134/95.3; 134/99.2; 134/902

(57) ABSTRACT

A cleaning apparatus cleaning a chuck is provided with a cleaning tank, an injection nozzle, a discharge nozzle, a liquid supply mechanism and a gas supply mechanism. The liquid supply mechanism has a supply tank, a heater and a liquid distribution mechanism so that the heater heats pure water supplied from the supply tank under the room temperature for forming warm water, reduced in electrical resistance, heated to a temperature higher than the room temperature. The liquid supply mechanism supplies the formed warm water to the cleaning tank through the liquid distribution mechanism. A vertical moving mechanism moves down a transport arm thereby dipping the chuck in the warm water and cleaning the chuck. Thus, the throughput of the cleaning apparatus cleaning the chuck is improved, the quantity of consumed gas is reduced and cleaning performance is improved.

### BACKGROUND OF THE INVENTION

1. Field of the Invention

The present invention relates to a technique of cleaning a chuck for holding and transporting a substrate.

2. Description of the Background Art

In steps of manufacturing a semiconductor substrate, a flexible substrate for a liquid crystal display or a substrate for a photomask (hereinafter simply referred to as “substrate”), a transporter is properly employed for moving the substrate to a prescribed position. For example, a transporter comprising a chuck for holding a substrate is proposed. However, a chemical liquid or the like adhering to the substrate disadvantageously also adheres to the chuck directly coming into contact with the substrate. If the chuck contaminated with the chemical liquid or the like transports another substrate as such, this substrate is also contaminated. Therefore, the chuck must be regularly kept clean.

A cleaning apparatus cleaning a chuck with a detergent (liquid) thereby keeping the chuck clean is proposed in general.

FIG. 8 is a schematic diagram showing a conventional cleaning apparatus 100 for cleaning a chuck 111. This cleaning apparatus 100 comprises a cleaning tank 101 storing pure water LQ serving as a detergent for cleaning the chuck 111 and a pair of injection nozzles 102 injecting nitrogen gas toward the chuck 111 of a transport arm 110. A vertical moving mechanism (not shown) can vertically move the chuck 111 along a Z-axis, for varying the relative position of the chuck 111 with respect to the cleaning tank 101 along the Z-axis direction.

The cleaning tank 101 is supplied with a sufficient quantity of pure water LQ, so that the chuck 111 is sufficiently dipped into the pure water LQ when the same is located on the lowermost position. The pair of injection nozzles 102 are so arranged as to direct injection ports thereof in prescribed directions respectively, for injecting nitrogen gas supplied from a gas supply mechanism (not shown) at prescribed timing.

The conventional cleaning apparatus 100 having the aforementioned structure cleans the chuck 111 along the following procedure: First, the vertical moving mechanism moves down the chuck 111 and dips the same in the cleaning tank 101.

After a lapse of a sufficient time, the vertical moving mechanism starts moving up the chuck 111.

At this time, the injection nozzles 102 start injecting the nitrogen gas in association with the upward movement of the chuck 111. In other words, the injection nozzles 102 injecting the nitrogen gas scan the upwardly moved chuck 111. Thus, the injection nozzles 102 spray the nitrogen gas thereby removing droplets (pure water LQ) adhering to the chuck 111.

When used under the room temperature (around 25° C.), the pure water LQ exhibits relatively high electrical resistance. If the vertical moving mechanism pulls up the chuck 111 from the pure water LQ under the room temperature after the chuck 111 is completely cleaned in the cleaning tank 101, therefore, static electricity is generated due to friction between the chuck 111 and the pure water LQ, to electrify the chuck 111. When the vertical moving mechanism pulls up the electrified chuck 111 from the cleaning tank 101, a relatively large quantity of pure water LQ adheres to the chuck 111 in the form of droplets, which in turn must be removed with the injection nozzles 102 over a long time.

Therefore, the conventional cleaning apparatus 100 vertically moves the chuck 111 while injecting the nitrogen gas from the injection nozzles 102 and repeatedly scans the chuck 111 with the injection nozzles 102 a plurality of times, thereby removing the droplets adhering to the chuck 111.

In the conventional cleaning apparatus 100 requiring a long time for removing the droplets, however, the throughput is disadvantageously reduced. Further, the cleaning apparatus 100 injecting the nitrogen gas from the injection nozzles 102 over a relatively long time also disadvantageously requires a large quantity of nitrogen gas.

### SUMMARY OF THE INVENTION

The present invention is directed to a technique of cleaning a chuck for holding and transporting a substrate.

Accordingly, a cleaning apparatus according to a preferred embodiment of the present invention comprises a cleaning tank storing a liquid for cleaning the chuck, a liquid supply mechanism supplying the liquid to the cleaning tank, an injection nozzle injecting gas toward the chuck thereby removing the liquid adhering to the chuck and a gas supply part supplying the gas to the injection nozzle, while the electrical resistance of the liquid at the temperature for cleaning the chuck in the cleaning tank is lower than the electrical resistance of pure water at the room temperature, whereby the quantity of charges is suppressed in the chuck to reduce the quantity of the liquid adhering to the chuck, so that the time for injecting the gas through the injection nozzle can be reduced. Therefore, the processing time as well as the quantity of the injected gas can be reduced.

The liquid supply mechanism replaces an old liquid in the cleaning tank with a new liquid in relation to the liquid, whereby cleaning efficiency can be improved.

The cleaning apparatus preferably further comprises a discharge nozzle discharging a detergent toward the chuck thereby cleaning the chuck, while the liquid supply mechanism supplies the detergent to the discharge nozzle, whereby the cleaning apparatus can perform further effective cleaning by employing a liquid flow for cleaning the chuck.

The detergent has the same liquid component as the liquid, whereby a supply path in the liquid supply mechanism can be rendered so common that the structure of the apparatus can be simplified.

More preferably, the cleaning apparatus further comprises a dispersion element dispersing the liquid in the cleaning tank, whereby the cleaning apparatus can uniformly supply the liquid into the cleaning tank.

The present invention is also directed to a substrate processing apparatus performing prescribed processing on a substrate. This substrate processing apparatus comprises at least one processing unit for executing the prescribed processing, a transporter transporting the substrate held by a chuck to the processing unit and a cleaning apparatus cleaning the chuck by dipping the chuck in a liquid, while the cleaning apparatus comprises a cleaning tank storing the liquid, a liquid supply mechanism supplying the liquid to the cleaning tank, an injection nozzle injecting gas toward the chuck thereby removing the liquid adhering to the chuck and a gas supply part supplying the gas to the injection nozzle, and the electrical resistance of the liquid at the temperature for cleaning the chuck in the cleaning tank is lower than the electrical resistance of pure water at the room temperature, whereby the quantity of charges is suppressed in the chuck to reduce the quantity of the liquid adhering to the chuck, so that the time for injecting the gas through the injection nozzle can be reduced. Therefore, the processing time as well as the quantity of the injected gas can be reduced.

The present invention is further directed to a cleaning apparatus for a transport tool for a substrate. This cleaning apparatus comprises a cleaning mechanism cleaning the transport tool with a liquid having electrical resistance lower than the electrical resistance of pure water at the room temperature and a removing mechanism removing a residual part of the liquid from the transport tool, whereby the quantity of charges is suppressed in the transport tool to reduce the quantity of the liquid adhering to the transport tool, so that the processing time of the removing mechanism for removing the liquid can be reduced.

Accordingly, a first object of the present invention is to improve the throughput and reduce the quantity of injected gas in cleaning processing for a chuck or a transport tool by reducing the time required for droplet removal processing.

Such a cleaning apparatus must more cleanly keep the chuck or the transport tool. Therefore, a second object of the present invention is to improve cleaning performance.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing the structure of a substrate processing apparatus according to a first preferred embodiment of the present invention;

FIG. 2 illustrates a cleaning apparatus according to the first preferred embodiment;

FIGS. 3 to 6 illustrate cleaning processing in the cleaning apparatus; and

FIG. 7 is a block diagram showing a liquid supply mechanism of a substrate processing apparatus according to a second preferred embodiment of the present invention; and

FIG. 8 illustrates a conventional cleaning apparatus.

### DESCRIPTION OF THE PREFERRED EMBODIMENTS

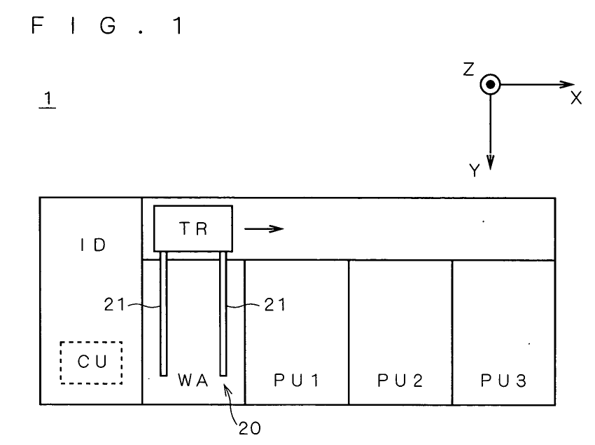

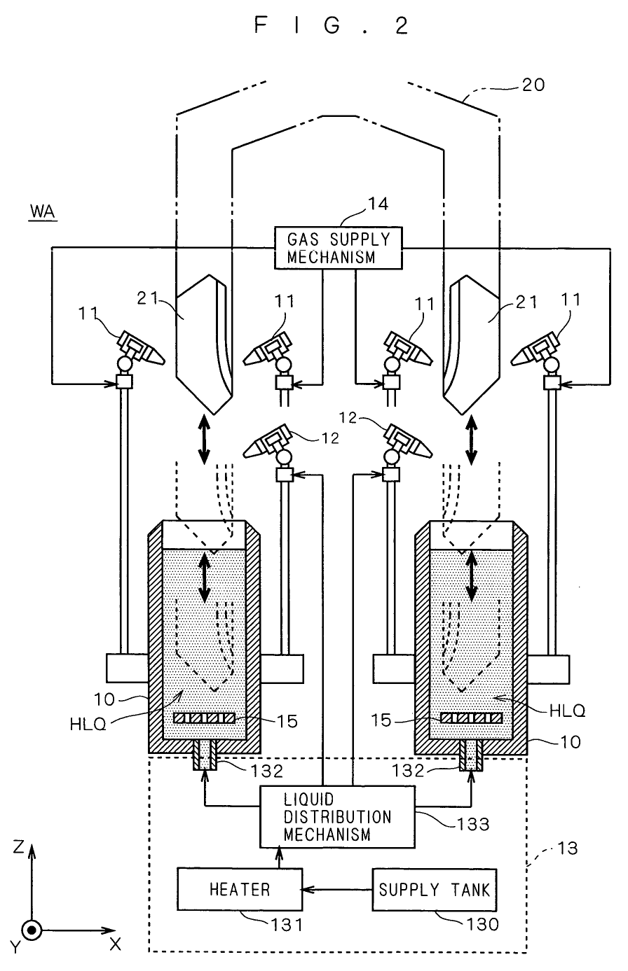

FIG. 1 is a schematic diagram showing the structure of a substrate processing apparatus 1 according to a first preferred embodiment of the present invention. Referring to FIG. 1, it is assumed that the Z-axis direction defines the vertical direction and the X-Y plane defines the horizontal plane for the convenience of illustration, with no restriction on the respective directions described below. This also applies to FIGS. 2 to 7.

The substrate processing apparatus 1 according to the first preferred embodiment comprises an indexer ID, processing units PU1 to PU3 (hereinafter generically referred to also as “processing units PU”), a transport robot TR, a cleaning apparatus WA and a control unit CU. The cleaning apparatus WA and the processing units PU1 to PU3 are aligned with the indexer ID.

The indexer ID has a function of receiving substrates introduced into the substrate processing apparatus 1 by an external transport mechanism or an operator. The indexer ID also has a function of discharging the substrates completely processed in the substrate processing apparatus 1 from the apparatus 1.

Each processing unit PU performs prescribed processing on the substrates. In the substrate processing apparatus 1 according to the first preferred embodiment, the processing unit PU1 is a drying unit drying the substrates, the processing unit PU2 is a pure water processing unit processing the substrates by dipping the same into pure water, and the processing unit PU3 is a cleaning unit cleaning the substrates with a prescribed chemical liquid.

The substrate processing apparatus 1 comprising such processing units PU has a function for serving as an apparatus executing a series of cleaning/drying processing in steps of manufacturing the substrates. The processing units PU, the functions of which are not restricted to the above, include at least a chemical liquid processing unit (corresponding to the processing unit PU3 serving as a cleaning unit) supplying the chemical liquid to the substrates.

The transport robot TR comprises transport arms 20 (see FIG. 2) holding the substrates with chucks 21 and a vertical moving mechanism (not shown) vertically moving the transport arms 20 along the Z-axis direction. The transport robot TR moves in the X-axis direction along arrow in FIG. 1 while holding the substrates with the chucks 21 thereby transporting the substrates between the processing units PU. The transport robot TR is enabled to simultaneously transport a plurality of substrates along the Y-axis direction in FIG. 2. In other words, the transport robot TR in the first preferred embodiment is constituted as the so-called batch-processible transporter. The surfaces of the chucks 21 are made of an electrical insulator such as resin.

FIG. 2 illustrates the cleaning apparatus WA in the first preferred embodiment. FIG. 2 sectionally shows cleaning tanks 10, dispersion plates 15 and pipes 132.

The cleaning apparatus WA comprises the cleaning tanks 10 storing pure water (hereinafter referred to as “hot water HLQ”) heated to a temperature higher than the room temperature, injection nozzles 11 injecting nitrogen gas toward the chucks 21, discharge nozzles 12 discharging the hot water HLQ toward the chucks 21, a liquid supply mechanism 13 supplying the hot water HLQ into the cleaning tanks 10, a gas supply mechanism 14 supplying nitrogen gas to the injection nozzles 11 and the dispersion plates 15.

Thus, the cleaning apparatus WA is constituted as an apparatus dipping the chucks 21 in the hot water HLQ stored in the cleaning tanks 10 thereby cleaning the chucks 21. The electrical resistance of pure water is generally reduced as the temperature is increased, and hence the hot water HLQ heated to the temperature higher than the room temperature exhibits electrical resistance lower than that at the room temperature.

The cleaning tanks 10, which are unlidded boxy structures, are provided therein with vessels for storing the hot water HLQ. These cleaning tanks 10 are provided on the bottoms thereof with openings for receiving the hot water HLQ, so that the pipes 132 of the liquid supply mechanism 13 are mounted on these openings. The hot water HLQ supplied to the cleaning tanks 10 overflows the upper portions of the cleaning tanks 10. The cleaning apparatus WA in the first preferred embodiment, which is a dual-tank apparatus provided with the two cleaning tanks 10 for the two chucks 21 respectively, may alternatively be formed by a single-tank apparatus provided with a large-sized cleaning tank.

The injection nozzles 11 extending along the Y-axis direction are provided in two pairs for the right and left chucks 21 respectively. In other words, the cleaning apparatus WA comprises four injection nozzles 11 in total. The injection nozzles 11 are communicatively connected with the gas supply mechanism 14, for injecting the nitrogen gas supplied from the gas supply mechanism 14 toward the chucks 21 thereby removing the hot water HLQ adhering to the chucks 21.

The discharge nozzles 12, extending along the Y-axis direction similarly to the injection nozzles 11, are provided in a pair for the right and left chucks 21, and discharge the hot water HLQ supplied from the liquid supply mechanism 13 toward the chucks 21.

The numbers of the injection nozzles 11 and the discharge nozzles 12 are not restricted to the above. The lengths of the cleaning tanks 10, the injection nozzles 11 and the discharge nozzles 12 along the Y-axis direction are defined in response to the length of the transport arms 20 along the Y-axis direction, to satisfy levels necessary for cleaning the chucks 21. The length of the transport arms 20 along the Y-axis direction is designed in response to the number of substrates simultaneously transported by the transport robot TR.

The liquid supply mechanism 13 is constituted of a supply tank 130 serving as a supply source for pure water at the room temperature, a heater 131 heating the pure water, the pipes 132 guiding the hot water HLQ (or the pure water) and a liquid distribution mechanism 133 properly distributing the hot water HLQ. The liquid supply mechanism 13 serves to supply the cleaning tanks 10 and the discharge nozzles 12 with the hot water HLQ. The control unit CU (not shown in FIG. 2) is connected to the liquid supply mechanism 13 in a state capable of transferring signals, and enabled to control the liquid supply mechanism 13.

The supply tank 130 stores the pure water supplied to the cleaning tanks 10 and the discharge nozzles 12. The pipes 132 guide the pure water stored in the supplied tank 130 and supply the same to the heater 131.

The heater 131 forms the hot water HLQ by heating the pure water supplied from the supply tank 130 to the temperature higher than the room temperature and feeding the same to the cleaning tanks 10 and the discharge nozzles 12 through the liquid distribution mechanism 133.

The liquid distribution mechanism 133 is mainly constituted of a plurality of on-off valves on-off controlled by the control unit CU and branch pipes. The liquid distribution mechanism 133 switches the on-off valves at prescribed timing in response to a control signal from the control unit CU, thereby distributing the hot water HLQ in response to the situation of progress of the cleaning processing.

The liquid distribution mechanism 133 in the first preferred embodiment distributes the hot water HLQ into the cleaning tanks 10 regardless of the quantities of the hot water HLQ stored in the cleaning tanks 10. If the liquid distribution mechanism 133 supplies the hot water HLQ in quantities exceeding the volumes of the cleaning tanks 10, therefore, the hot water HLQ overflows the upper portions of the cleaning tanks 10. Thus, the liquid supply mechanism 13 can substitute new hot water HLQ for the old hot water HLQ stored in the cleaning tanks 10. Thus, the cleaning apparatus WA, capable of inhibiting the cleaning tanks 10 from residual of contaminated old liquids, can be improved in cleaning performance.

In the substrate processing apparatus 1 according to the first preferred embodiment, further, the liquid supply mechanism 13 supplies the same liquid as that supplied to the cleaning tanks 10 to the discharge nozzles 12 so that a supply path (path between the supply tank 130 and the liquid distribution mechanism 133) in the liquid supply mechanism 13 can be rendered in common, whereby the structure of the substrate processing apparatus 1 may not be complicated. The supply tank 130 and the heater 131 may alternatively be provided outside the substrate processing apparatus 1. In other words, the liquid distribution mechanism 133 may distribute the pure water heated to the temperature higher than the room temperature to the cleaning tanks 10 and the discharge nozzles 12 from outside the substrate processing apparatus 1. Further, the liquid distribution mechanism 133 may comprise a mechanism, such as a driving pump, feeding the hot water HLQ.

The dispersion plates 15 are platelike members provided in the cleaning tanks 10 respectively. These dispersion plates 15 are arranged on positions opposed to the openings provided on the bottoms of the cleaning tanks 10 to be parallel to the X-Y plane. A plurality of holes are uniformly punched out in the surface of each dispersion plate 15 to pass through the same in the Z-axis direction. Therefore, it follows that the hot water HLQ supplied to the cleaning tanks 10 is first discharged toward the dispersion plates 15 to pass through the holes uniformly provided on the surfaces of the dispersion plates 15.

Thus, the substrate processing apparatus 1 can newly supply the hot water HLQ into the cleaning tanks 10 in a uniformed state. Therefore, the substrate processing apparatus 1 can prevent an old liquid contaminated with the chucks 21 dipped therein from partially remaining in the cleaning tanks 10, for quickly substituting the new liquid for the old liquid. Thus, the substrate processing apparatus 1 can improve the cleaning performance of the cleaning apparatus WA.

In response to a control signal from the control unit CU, the gas supply mechanism 14 supplies the nitrogen gas to the injection nozzles 11 in response to the situation of progress of the cleaning processing. The gas supplied by the gas supply mechanism 14 is not restricted to the nitrogen gas but may alternatively be properly prepared from clean gas having stable quality.

The cleaning apparatus WA comprising temperature sensors (not shown) in the cleaning tanks 10 is enabled to output results of detection to the control unit CU. Thus, the control unit CU can properly control the respective structures in response to the temperature of the hot water HLQ in the cleaning tanks 10. For example, the control unit CU can make control to start cleaning the chucks 21 after the temperature of the hot water HLQ in the cleaning tanks 10 is sufficiently increased and the electrical resistance at the liquid temperature for cleaning the chucks 21 is sufficiently lower than that of the pure water at the room temperature.

Referring again to FIG. 1, the control unit CU comprises a CPU (not shown) performing arithmetic processing and a storage part (not shown) storing various data such as set values and programs. The control unit CU also comprises an operation part for the operator for inputting instructions in the substrate processing apparatus 1 and an output part outputting data to the operator.

The control unit CU is connected with the respective structures of the substrate processing apparatus 1 in a state capable of transferring signals, and operates on the basis of the programs previously stored in the storage part thereby controlling the structures.

The substrate processing apparatus 1 according to the first preferred embodiment has the aforementioned functions and structures. Operations of the substrate processing apparatus 1 for cleaning the chucks 21 are now described. The substrate processing apparatus 1 performs the following operations on the basis of control signals from the control unit CU, unless otherwise stated. Description of processing performed in each processing unit PU is omitted.

The substrate processing apparatus 1 cleans the chucks 21 with the cleaning apparatus WA when the transport robot TR transports no substrates while the processing units PU process the substrates, for example. In advance of the cleaning processing, the liquid supply mechanism 13 supplies prescribed quantities of hot water HLQ into the cleaning tanks 10 through the liquid distribution mechanism 13.

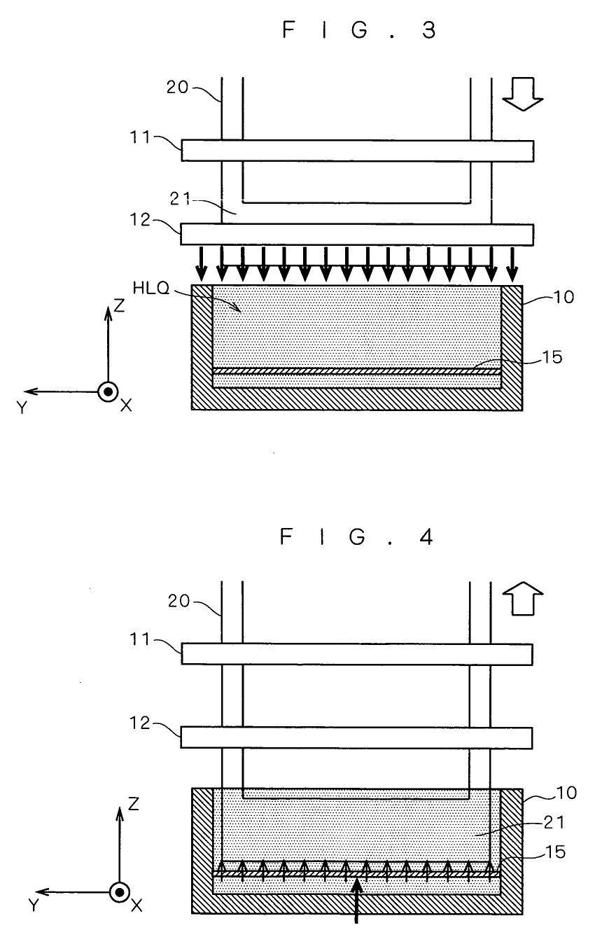

FIGS. 3 to 6 show the cleaning processing in the cleaning apparatus WA. First, the transport robot TR arranges each transport arm 20 above each cleaning tank 10 of the cleaning apparatus WA. Then, the transport robot TR moves down the transport arm 20 (each chuck 21) in the (−Z) direction. When the transport robot TR starts moving down the chuck 21, the liquid distribution mechanism 133 supplies the hot water HLQ to each discharge nozzle 12, which in turn starts discharging the hot water HLQ (FIG. 3). Thus, the discharge nozzle 12 scans the downwardly moved chuck 21.

Thus, the cleaning apparatus WA strikes the chuck 21 with a stream of the hot water HLQ discharged from the discharge nozzle 12 thereby removing contaminants adhering to the chuck 21. Therefore, the cleaning performance is more improved as compared with the cleaning apparatus 100 shown in FIG. 8 simply dipping the chuck 111 in the pure water LQ.

When completely dipping the chuck 21 in the hot water HLQ stored in the cleaning tank 10, the transport robot TR stops moving down the transport arm 20. Further, the liquid distribution mechanism 133 stops distributing the hot water HLQ to each discharge nozzle 12, which in turn stops discharging the hot water HLQ. The discharge nozzle 12 may stop discharging the hot water HLQ not at this timing but when completely scanning the chuck 21.

Around this operation, the liquid distribution mechanism 133 starts supplying the hot water HLQ to each cleaning tank 10. Each dispersion plate 15 disperses the hot water HLQ supplied from the bottom of each cleaning tank 10 through each pipe 132 as shown by arrows in FIG. 4, for uniformly supplying the same into the cleaning tank 10.

Thus, the new hot water HLQ is uniformly supplied into each cleaning tank 10 substantially from the overall bottom surface in the (+Z) direction, while the old hot water HLQ overflows the upper portion of the cleaning tank 10. Thus, the cleaning apparatus WA can quickly discharge the contaminants separated from the chuck 12 along with the old hot water HLQ without leaving the same in the cleaning tank 10, thereby improving the cleaning performance.

The hot water HLQ is superior in removability for contaminants such as acid, alkali or metals (cleaning performance) to the pure water at the room temperature, thereby also improving the cleaning performance of the cleaning apparatus WA.

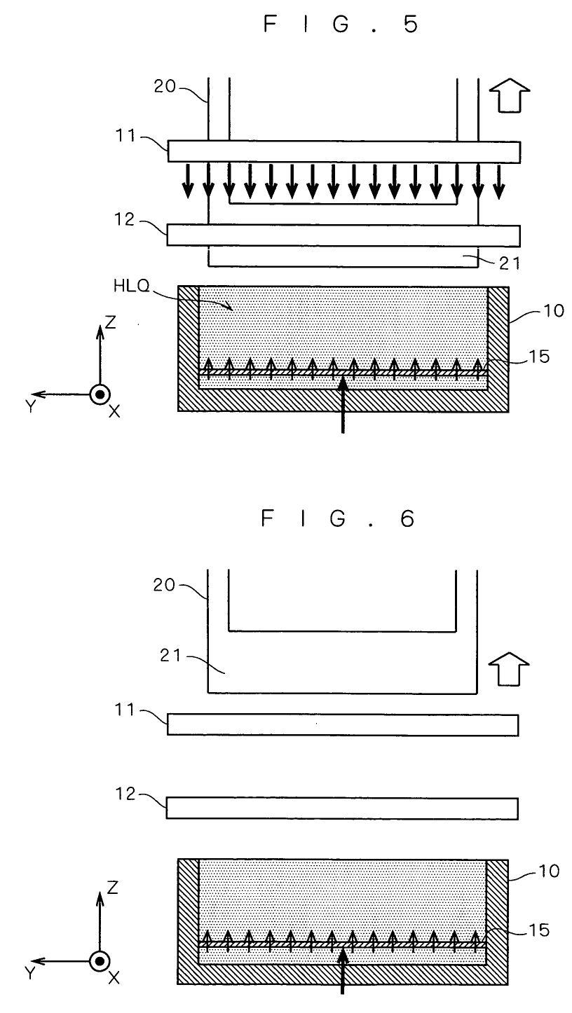

After dipping the chuck 21 in the hot water HLQ for a prescribed time, the transport robot TR starts moving up the transport arm 20 (FIG. 4). In parallel with this, the gas supply mechanism 14 supplies the nitrogen gas to each injection nozzle 11 (FIG. 5). Thus, the injection nozzle 11 injects the nitrogen gas toward the chuck 21 and starts scanning the chuck 21.

If the transport robot TR rapidly moves up the transport arm 20, a relatively large quantity of droplets adhere to the pulled-up chuck 21. Therefore, the transport robot TR moves up the transport arm 20 at a speed sufficiently lower than that for moving down the transport arm 20. Thus, the quantity of droplets adhering to the chuck 21 can be reduced.

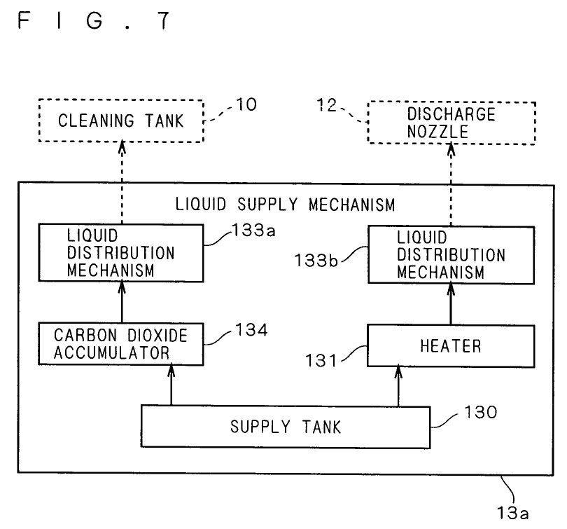

When the chuck 21 reaches a position upward beyond the injection nozzle 11 due to the operation of the transport robot TR moving up the transport arm 20, the gas supply mechanism 14 stops supplying the nitrogen gas so that the injection nozzle 11 stops injecting the nitrogen gas. Thus, the injection nozzle 11 stops scanning the chuck 21 (FIG. 6). In other words, the injection nozzle 11 scans the chuck 21 only once in the cleaning apparatus WA.

The cleaning apparatus WA of the substrate processing apparatus 1 according to the first preferred embodiment, employing the hot water HLQ exhibiting the electrical resistance lower than that of the pure water at the room temperature as the liquid for cleaning the chucks 21, can suppress the quantities of charges of static electricity on the chucks 21 to low levels. Thus, the quantities of droplets adhering to the chucks 21 pulled up from the cleaning tanks 10 are reduced as compared with that in the conventional cleaning apparatus 100. In other words, drainability of the chucks 21 is improved.

Thus, the cleaning apparatus WA, capable of reducing the time required for removing droplets by improving the drainability of the chucks 21, can sufficiently remove droplets adhering to the chucks 21 through the single scanning with the injection nozzles 11 as described above. Therefore, the cleaning apparatus WA of the substrate processing apparatus 1 according to the first preferred embodiment is improved in throughput, and can suppress the quantity of the used nitrogen gas.

When the transport arm 20 reaches a prescribed position, the transport robot TR stops moving up the transport arm 20. The liquid distribution mechanism 133 stops supplying the hot water HLQ to each cleaning tank 10 when a prescribed time elapses for sufficiently substituting the new hot water HLQ for the old hot water HLQ. Thus, the substrate processing apparatus 1 completes the cleaning processing for the chucks 21.

The substrate processing apparatus 1 according to the first preferred embodiment, employing the hot water HLQ heated to the temperature higher than the room temperature as the liquid for cleaning the chucks 21 by dipping the same therein, can reduce the quantities of charges of static electricity in the chucks 21 as well as the quantities of droplets adhering to the chucks 21 in the cleaning processing. Thus, the substrate processing apparatus 1 can reduce the time for removing the droplets, improve the throughput and suppress the quantity of the consumed nitrogen gas.

Further, the cleaning performance of the cleaning apparatus WA is improved due to the hot water HLQ having higher cleaning ability than the pure water at the room temperature.

In addition, the substrate processing apparatus 1, capable of cleaning the chucks 21 with liquid streams due to the discharge nozzles 12 discharging the hot water HLQ toward the chucks 21 for cleaning the same, can perform further effective cleaning.

Further, the liquid supply mechanism 13 supplies the same hot water HLQ as that stored in the cleaning tanks 10 to the discharge nozzles 12 so that the supply path in the liquid supply mechanism 13 can be rendered common, whereby the structure of the substrate processing apparatus 1 can be simplified.

In addition, the substrate processing apparatus 1 comprising the dispersion plates 15 dispersing the hot water HLQ supplied from the liquid supply mechanism 13 in the cleaning tanks 10 can uniformly supply the hot water HLQ into the cleaning tanks 10.

The first preferred embodiment has been described with reference to the example of employing the pure water (hot water HLQ) heated to the temperature higher than the room temperature as the liquid having lower electrical resistance than the pure water at the room temperature. However, this liquid is not restricted to the heated pure water but another liquid may alternatively be employed so far as the same can be readily drained from chucks and is removable from the chucks without leaving any residue (solid component or the like).

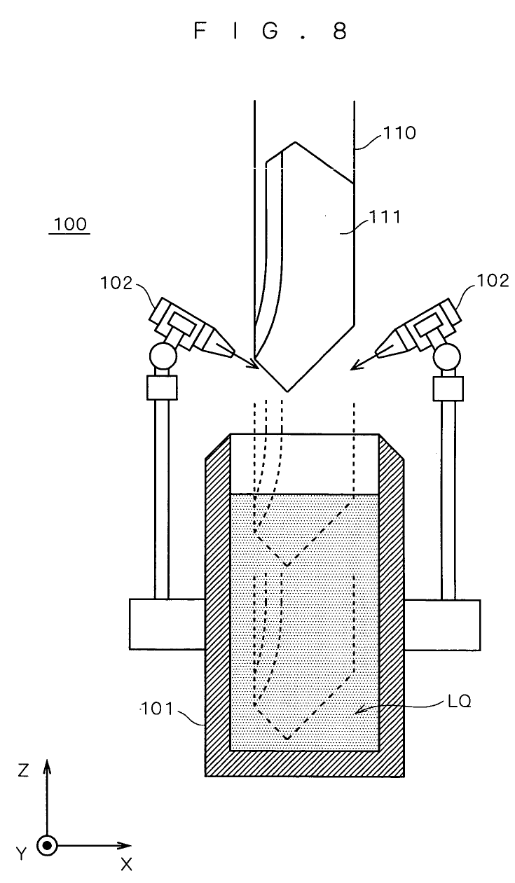

FIG. 7 is a block diagram showing a liquid supply mechanism 13a of a substrate processing apparatus 1 according to a second preferred embodiment of the present invention formed on the basis of this principle. The substrate processing apparatus 1 according to the second preferred embodiment is similar in structure to the substrate processing apparatus 1 according to the first preferred embodiment except the liquid supply mechanism 13a, and hence redundant description is properly omitted.

The liquid supply mechanism 13a comprises a carbon dioxide accumulator 134, and is provided with supply paths for a cleaning tank 10 and a discharge nozzle 12 as separate paths respectively.

The carbon dioxide accumulator 134 is an apparatus having a function of dissolving carbon dioxide (CO₂) in a liquid passing therethrough. According to the second preferred embodiment, a supply tank 130 supplies pure water of the room temperature to the carbon dioxide accumulator 134, which in turn generates carbonated water and feeds the same to the cleaning tank 10. In other words, a cleaning apparatus WA according to the second preferred embodiment employs the carbonated water as a liquid for cleaning a chuck 21.

A liquid distribution mechanism 133a switches an on-off valve in response to a control signal from a control unit CU, thereby distributing the carbonated water into the cleaning tank 10. Another liquid distribution mechanism 133b distributes hot water HLQ to the injection nozzle 12, similarly to the liquid distribution mechanism 133 in the first preferred embodiment.

As hereinabove described, the cleaning apparatus WA according to the second preferred embodiment can employ the carbonated water as the liquid for cleaning the chuck 21. The carbonated water has lower electrical resistance than the pure water at the room temperature and high removability for contaminants, whereby the substrate processing apparatus 1 according to the second preferred embodiment can attain effects similar to those of the substrate processing apparatus 1 according to the first preferred embodiment.

The cleaning apparatus WA may alternatively employ hydrogen peroxide water (H₂O₂) as the liquid for cleaning the chuck 21. In this case, the carbon dioxide accumulator 134 may be replaced with an apparatus for adding hydrogen peroxide water to the pure water supplied from the supply tank 130.

While the preferred embodiments of the present invention have been described, the chucks 21 in the first preferred embodiment may alternatively be dipped in the cleaning tanks 10 at least twice, for example. In other words, the transport robot TR may move down the temporarily pulled-up chucks 21 again for dipping the same in the cleaning tanks 10. In this case, the injection nozzles 11 may inject the nitrogen gas only when the transport robot TR finally moves up the chucks 21.

The liquid distribution mechanism 133 may alternatively regularly supply the hot water HLQ into the cleaning tanks 10.

Further, the substrate processing apparatus 1 according to the first and second preferred embodiments formed to vertically move the transport arms 20 may alternatively be formed to vertically move the cleaning tanks 10, the injection nozzles 11 and the discharge nozzles 12 in association with each other. In other words, the substrate processing apparatus 1 according to the first and second preferred embodiments may be in any structure so far as the relative distance between the chucks 21 and the cleaning to us 10 is changeable.

The cleaning apparatus WA may alternatively be provided with a sensor detecting the positions of the chucks 21 in the Z-axis direction, for operating the structures of the cleaning apparatus WA in response to an output from this sensor.

While the invention has been shown and described in detail, the foregoing description is in all aspects illustrative and not restrictive. It is therefore understood that numerous modifications and variations can be devised without departing from the scope of the invention.

What is claimed is:

1. A cleaning apparatus cleaning a chuck holding a substrate, comprising:
a cleaning tank storing a liquid for cleaning said chuck;
a liquid supply mechanism supplying said liquid to said cleaning tank;
an injection nozzle injecting gas toward said chuck thereby removing said liquid adhering to said chuck; and
a gas supply part supplying said gas to said injection nozzle, wherein
the electrical resistance of said liquid at the temperature for cleaning said chuck in said cleaning tank is lower than the electrical resistance of pure water at the room temperature.

2. The cleaning apparatus according to claim 1, wherein
said liquid is pure water heated to a temperature higher than the room temperature by a heating element.

3. The cleaning apparatus according to claim 1, wherein
said liquid is carbonated water.

4. The cleaning apparatus according to claim 1, wherein
said liquid is hydrogen peroxide water.

5. The cleaning apparatus according to claim 1, wherein
said liquid supply mechanism replaces an old liquid in said cleaning tank with a new liquid in relation to said liquid.

6. The cleaning apparatus according to claim 1, further comprising a discharge nozzle discharging a detergent toward said chuck thereby cleaning said chuck, wherein
said liquid supply mechanism supplies said detergent to said discharge nozzle.

7. The cleaning apparatus according to claim 6, wherein
said detergent has the same liquid component as said liquid.

8. The cleaning apparatus according to claim 1, further comprising a dispersion element dispersing said liquid in said cleaning tank.

9. A substrate processing apparatus performing prescribed processing on a substrate, comprising:
at least one processing unit for executing said prescribed processing;
a transporter transporting said substrate held by a chuck to said processing unit; and
a cleaning apparatus cleaning said chuck by dipping said chuck in a liquid, said cleaning apparatus comprising:
a cleaning tank storing said liquid,
a liquid supply mechanism supplying said liquid to said cleaning tank,
an injection nozzle injecting gas toward said chuck thereby removing said liquid adhering to said chuck, and
a gas supply part supplying said gas to said injection nozzle, wherein
the electrical resistance of said liquid at the temperature for cleaning said chuck in said cleaning tank is lower than the electrical resistance of pure water at the room temperature.

10. A cleaning apparatus for a transport tool for a substrate, comprising:
a cleaning mechanism cleaning said transport tool with a liquid having electrical resistance lower than the electrical resistance of pure water at the room temperature; and
a removing mechanism removing a residual part of said liquid from said transport tool.

11. The cleaning apparatus according to claim 10, wherein
said removing mechanism comprises a gas injection mechanism injecting inert gas toward said transport tool thereby removing said residual part of said liquid from said transport tool.
